(19) United States
(12) Patent Application Publication
(10) Pub. No.: US 2014/0149440 A1
(43) Pub. Date: May 29, 2014

(54) User Generated Context Sensitive Information Presentation

(71) Applicant: DST TECHNOLOGIES, INC., Kansas City, MO (US)

(72) Inventors: Stephen J. Mason, Lawrence, KS (US); Deni Esposito, Richmond Hill (CA); Chin Hsu, North York (CA); Paul Martin Ives, Toronto (CA); Linh Hua, Mississauga (CA)

(73) Assignee: DST TECHNOLOGIES, INC., Kansas City, MO (US)

(21) Appl. No.: 13/686,773

(22) Filed: Nov. 27, 2012

(51) Int. Cl. G06F 17/30

(52) U.S. Cl. CPC G06F 17/30964
USPC 707/758

(57) ABSTRACT

In order to increase the efficiency of the worker and ultimately decrease the cost of the worker performing work-related tasks, a method and a system for presenting information relevant to user activity of a user at a computing device is provided. A database including data records that each include information relevant to at least one user activity and at least one identifier identifying the at least one user activity is provided. Activities of a user are monitored and compared to the data records of the database. When a monitored activity matches an identifier of one of the data records, the information corresponding to the matched data record is presented to the user.

### BACKGROUND

A worker that uses a computer to complete a number of work-related tasks may perform a particular task repetitively over a period of time (e.g., one work day). The worker may then transition to another work-related task that the worker has never encountered or encounters infrequently (e.g., an infrequently encountered task). If the worker does not know or remember how to perform the infrequently encountered task, the worker may search for and retrieve procedural information corresponding to the infrequently encountered task to aid in the completion of the task. This may detract from the worker's efficiency, resulting in increased costs, etc.

For example, document processing may involve classifying documents into categories (e.g., insurance claims or powers of attorney) and/or confirming that requirements have been met (e.g., a signature is present, a notarization, if required, is present, and/or a medallion stamp, if required, is present). Document processing may also involve the conversion of typed and handwritten text on paper-based and electronic documents into electronic information via manual input or using, for example, handwriting recognition software and/or optical character recognition software (e.g., automated document processing). An enterprise that processes documents for a number of different clients (e.g., insurance companies) may employ a large number of workers that facilitate the document processing. The workers may categorize the documents, confirm that requirements have been met for the documents, and/or manually enter the typed and handwritten text on the paper-based and electronic documents, such as when the automated document processing fails for a particular document.

The workers may each be trained to work with documents for only one client (e.g., a first client or a second client), of which those documents, or subsets thereof, share common characteristics, such as the location of document fields or other features, a common format or otherwise required processing unique to the particular client, for which the worker is specifically trained. For example, a worker may be trained to perform a set of tasks with regard to all of the documents for the first client. The worker may, however, typically encounter a smaller subset of the documents on a day-to-day basis. For example, the worker may be trained to process (e.g., enter data from one or more fields of the documents for the one client) 100 different types of documents for the first client but may typically encounter only 20 document types on a day-to-day basis. Although the worker has received the appropriate data processing training, the worker may not remember how to process one of the 80 other document types when the one type is encountered.

If the worker is assigned to work with documents for the second client, for which the worker has not received training, or the worker encounters a document type that is not typically processed (e.g., infrequently encountered documents), the worker may access client-specific rules stored in a database to determine how the infrequently encountered document is to be processed. This slows down the processing of documents by the worker, thus decreasing the efficiency of the worker and increasing the cost of processing the documents.

### BRIEF DESCRIPTION OF THE DRAWINGS

The examples of the invention described below can be better understood with reference to the following figures. The components in the figures are not necessarily to scale, emphasis instead being placed upon illustrating the principles of the invention. In the figures, like reference numerals designate corresponding parts throughout the different views.

FIG. 1 shows one embodiment of a system for presenting information relevant to user activity;

FIG. 2 shows one embodiment of a computer system for use with the system of FIG. 1; and

FIG. 3 shows a flow chart of one embodiment of a method for presenting information relevant to user activity.

### DETAILED DESCRIPTION OF THE DRAWINGS

In order to increase the efficiency of a worker and ultimately decrease the cost of the worker performing work-related tasks, a method and a system for presenting information relevant to user activity of a user at a computing device is provided. A database including data records that each include information relevant to at least one user activity and at least one identifier identifying the at least one user activity is provided. Activities of a user are monitored and compared to the data records of the database. When a monitored activity matches an identifier of one of the data records, the information corresponding to the matched data record is presented to the user.

For example, the worker may be assigned document processing tasks for a client that the worker infrequently works for. The worker may be assigned the document processing tasks via a graphical user interface displayed on a computing device. The system may monitor inputs (e.g., mouse clicks, text input via a keyboard, etc.) by the worker to the computing device. When one of the monitored inputs matches an identifier of one of the data records included in the database, the system may provide users with focused client-specific exceptions and/or instructions for completing the document processing tasks. The instructions for completing the document processing tasks may be step-by-step procedural job aids or other indicators that correspond to the client and the type of the work. If the worker needs additional information to complete the document processing tasks, the worker may search the database or another database for the additional information. The system may require that the worker acknowledge (e.g., click OK) that the worker read the instructions before the worker may proceed to perform the document processing tasks.

Productivity of the worker may increase, as the worker will automatically be provided with procedural information relating to the assigned work, thus reducing or eliminating the need for ad hoc searches. Error rates when working through the document processing tasks may also be reduced.

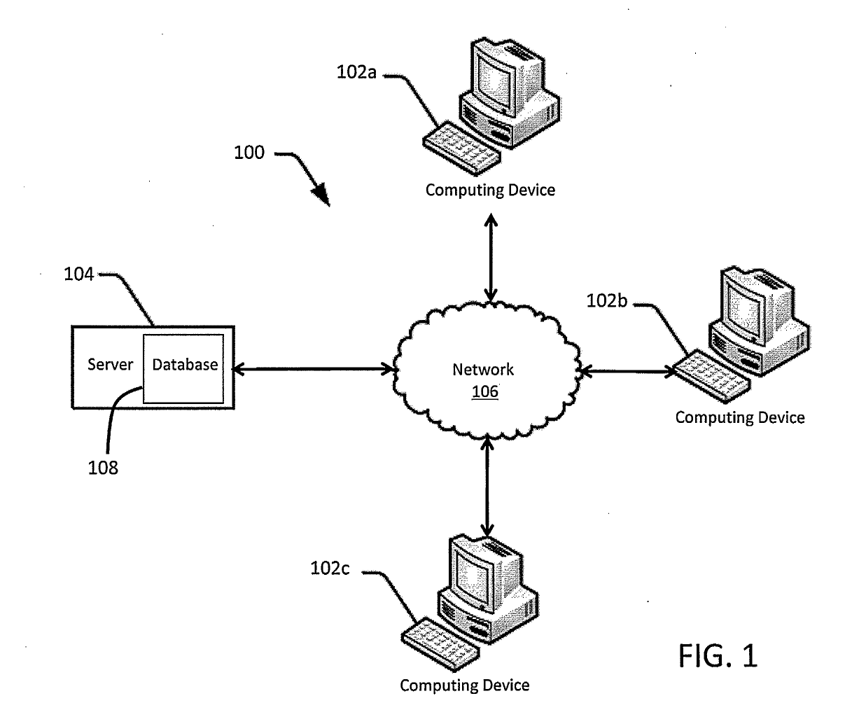

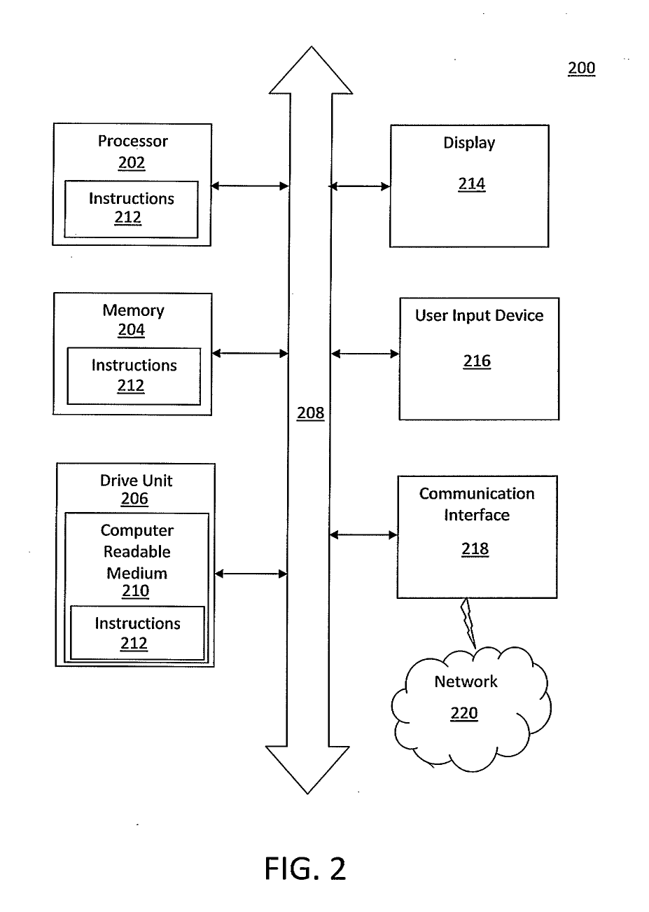

FIG. 1 shows one embodiment of a system 100 for presenting information relevant to user activity. The system 100 includes a plurality of computing devices 102 (e.g., a first computing device 102a, a second computing device 102b, and a third computing device 102c), each of which may be a computing device 200 described below with respect to FIG. 2, in communication with a server 104 via a network 106. The server 104 includes a database 108. Users (e.g., workers at an enterprise) may use the plurality of computing devices 102 to be assigned and/or work on work-related tasks. For example, a first worker may use the first computing device 102a, a second worker may use the second computing device 102b, and a third worker may use the third computing device 102c. More than one worker may use the first computing device 102a, the second computing device 102b, and/or the third computing device 102c. For example, the first worker, the second worker, and the third worker may share the first computing device 102a. The system 100 may include more or fewer computing devices 102. Each computing device of the plurality of computing devices 102 and the server 104 may be located in the same or different rooms, the same or different facilities, or the same or different enterprise campuses. In one embodiment, the plurality of computing devices 102 may be operated by a first enterprise, and the server 104 may be operated by a second enterprise. In another embodiment, the workers may be “work at home” workers that use their own computing devices to sign on and take on work-related tasks to perform. To that end, this whole system may be delivered via a web page/site. In other words, the plurality of computing devices 102 may be operated in a first geographic location, and the server 104 may be operated in a second geographic location, the second geographic location being remote from the first geographic location. The database 108 may be included within the server 104 or may be separate from the server 104. The system 100 may include more databases 108 within the server 104 and/or separate from the server 104.

The database 108 may include a plurality of data records. Each data record of the plurality of data records may include data (e.g., information) relevant to at least one user activity of a plurality of user activities. At least some data of each data record may be data for helping the worker complete a work-related task. For example, the data may be for client-specific exceptions and/or instructions for completing the work-related task. The instructions may be step-by-step procedural job aids that correspond to the work-related task. In one embodiment, the work related task involves processing documents. The step-by-step procedural job aids may be for one or more documents and/or one or more tasks related to the client. For example, the step-by-step procedural job aides may list fields on the documents to be identified and input by the worker at a computing device (e.g., the first computing device 102a) of the plurality of computing devices 102a, and/or tests to be run on the documents at the first computing device 102a. The plurality of data records may include, for example, text files, XML data, image data (e.g., JPEG and/or MPEG), and/or video data. The plurality of data records may include any number of other data types including, for example, data that controls one or more user interfaces of the plurality of computing devices 102 to actively guide the user through work-related task performance. The plurality of data records may include other information including, for example, possible solutions for overcoming an error when the error is encountered and change histories for programmers.

Each data record of the plurality of data records may also include at least one identifier identifying the at least one corresponding user activity of the plurality of user activities. The identifiers may, for example, be textual data representing the plurality of activities. The identifiers may be a word, a number, a letter, a symbol, or any combination thereof. The plurality of user activities may include any number of user activities at a computing device (e.g. the first computing device 102a) of the plurality of computing devices 102 including, for example, opening a file, selecting a portion of a graphical user interface (e.g., a window) at the first computing device 102a, receiving data, and/or transmitting data. User activities provide guidance as to which information may be helpful in completing the work-related task. For example, if the user selects a portion of the graphical user interface that corresponds to client A and/or a client A work-related task (e.g., a window having a title that corresponds to client A) or opens a software program or a file that corresponds to client A and/or a client A work-related task, this user activity provides guidance as to which information (e.g., client A-specific step-by-step procedural job aids) may be helpful to the worker in completing a work-related task (e.g., a client A-specific task).

In one embodiment, the plurality of data records may be user-generated. The plurality of data records may be generated by one or more of the workers at at least one computing device of the plurality of computing devices 102. In one embodiment, the one or more workers may have knowledge of procedures for a specific client and may generate the client-specific exceptions and/or instructions for completing the work-related task. Alternatively, at least some data records of the plurality of data records may be generated by users at computing devices outside of the system 100. The one or more workers and/or the outside users may also define the correspondence of the data records with user activities via the identifiers.

The one or more workers may generate the plurality of data records, for example, by typing or speaking into the at least one computing device 102. The one or more workers may, for example, use a word processing program or a separate pop-up module to generate some or all data records of the plurality of data records. In one embodiment, the system 100 may be at least partially integrated with an instant messenger software program, such that at least one data record of the plurality of data records may be generated based on communications between at least two of the workers within the instant messenger software program.

The one or more workers may save the plurality of data records to the database 108. A plurality of the workers may collaborate on one data record of the plurality of data records. For example, the first worker may generate the one data record, and the second worker may edit the one data record by changing and/or adding to the one data record. The one data record may identify the first worker and the second worker and may identify the changes and/or the additions to the one data record. The one data record may include other information including, for example, the date and time the one data record was created and the date and time the one data record changes and/or additions were made to the one data record.

The system 100 may require authorization from the one or more workers to generate and/or edit the plurality of data records. For example, only certain workers with certain roles within the enterprise may generate and/or edit the plurality of data records. The database 108 or another database may include authorization data identifying workers authorized to generate and/or edit the plurality of data records. Each of the one or more workers may input a username and/or a password before saving a generated or edited data record to the database 108. Alternatively or additionally, each of the one or more workers may be identified by an IP address associated with the computing device 102 that the worker uses to generate and/or edit the data record. The server 104 or another computing device may compare the username and/or password to the authorization data stored in the database 108 or the other database to determine if the worker is authorized to generate and/or edit the data record. Each of the one or more workers may be authorized to generate and/or edit some or all data records of the plurality of data records. In one embodiment, before the generated or edited data record may be saved to the database 108, the data record is forwarded to another worker or user for review. The other worker may, for example, be a supervisor of the worker generating and/or editing the data record. The generated or edited data record may be automatically forwarded to the supervisor, or the server 104 may prevent the worker from saving the data record to the database 108 until the data record is reviewed. The authorization to generate and/or edit the data records may be set by the one or more workers and/or the other worker (e.g., the supervisor), for example, within social network pages for the one or more workers and/or the other worker. For example, such social network pages may be generated by the social networking system disclosed in U.S. patent application Ser. No. 13/468,334, titled “Internal Social Network for an Enterprise and Applications Thereof,” filed on May 10, 2012, which is hereby incorporated by reference. The review helps prevent errors within the data record, thus increasing efficiency and decreasing the cost associated with completing the work-related task.

The server 104 monitors activities of each of the workers at the plurality of computing devices 102. For example, the server 104 may monitor data traffic to and/or from each computing device of the plurality of computing devices 102 via the network 106. The server 104 may run one or more software programs that intercept packets to and/or from each computing device of the plurality of computing devices 102 and examine contents of the intercepted packets. In one embodiment, the one or more software programs that intercept packets to and/or from each of the computing devices 102 may be installed on another device within the network 106; the other device may forward the intercepted packets to the server 104. Additionally or alternatively, each computing device of the plurality of computing devices 102 may run one or more software programs operable to monitor activities of the worker using the computing device 102 and/or examine data stored at the computing device 102. In one embodiment, the one or more software programs running on the computing device 102 and operable to monitor activities of the worker using the computing device 102 are independent of other software programs running on the computing device 102, so that the one or more software programs may monitor activities across programs and within the operating system (OS) of the computing device 102 (e.g., not just within a single program running on the computing device 102).

In one embodiment, the server 104 or another computing device may receive data from devices worn by at least some of the workers at the plurality of computing devices 102 to monitor the activities of the workers. The devices may be, for example, electrocardiography (ECG) devices, electroencephalography (EEG) devices, other devices that detect biological artifacts, or a combination thereof. The received data may represent, for example, electrical activity of the heart of a worker (e.g., ECG) or electrical activity along the scalp of a worker (e.g., EEG).

The monitored activities of the worker may include any number of activities including, for example, opening a file, selecting a portion of a graphical user interface (e.g., a window) displayed at the computing device 102, receiving data, and/or transmitting data. In one embodiment, the actions that may be monitored are mouse movements and keyboard interactions (or delays there between). Those actions are then interpreted to determine if a file is being opened, if a user is switching tasks, etc. Pauses in action may indicate indecisiveness. The system may attempt to discern when intervention is necessary and when intervention is not necessary. The system may also monitor an operating system (OS) of the computing device 102 or a program running on the computing device 102 for events such as, for example, mouse clicking events, file opening events, etc. Data representing the monitored activities of the worker may be generated and transmitted to the server 104. In one embodiment, data representing a subset of the monitored activities (e.g., only file opens and mouse clicks) may be generated and transmitted to the server 104. The plurality of computing devices 102 may be monitored in any number of other ways. Less than all computing devices of the plurality of computing devices 102 may be monitored. The data representing the monitored activities may be displayed and/or stored at the first computing device 102a, the second computing device 102b, the third computing device 102c, the server 104, and/or another computing or storage device.

In one embodiment, the server 104 or another computing device may analyze the data representing the monitored activities to determine, for example, when a worker (e.g., the first worker) is away from a computing device (e.g., the first computing device 102a) for an extended period of time. For example, the server 104 may analyze the data representing the monitored activities to determine when a display of the first computing device 102a, for example, has transitioned into screen lock mode. The screen lock mode may indicate that the first worker has been away from the first computing device 102a for a predetermined amount of time (e.g., fifteen minutes, as set at the first computing device 102a). The server 104 may additionally or alternatively analyze the data representing the monitored activities to determine a keyboard idle time. The keyboard idle time may represent a time period, during which the first worker, for example, has not input at an input device (e.g., a keyboard) of the first computing device 102a. The determination of when displays of the plurality of computing devices 102 transition into the screen lock mode and the determined keyboard idle times may indicate to the server 104 and/or a worker at or outside the enterprise (e.g., the second worker) which of the workers at the enterprise are on break, who is productive (e.g., has little idle time), and who is unproductive (e.g., has a large amount of idle time). This information may be used by the server 104 and/or a worker at or outside the enterprise (e.g., the second worker), for example, to better allocate work to the workforce. For example, the first worker may be unproductive because the work-related tasks are too easy, and the first worker is often helping others. In such a case, the first worker may be allocated different and/or more difficult work to better utilize the first worker's skill set. This information may also be used, for example, to re-allocate work to the workforce. For example, when the first worker is idle for fifteen minutes, a portion of the work assigned to the first worker is re-allocated to another worker at the enterprise (e.g., the third worker) to increase the overall efficiency of the workforce at the enterprise. The determination of when displays of the plurality of computing devices 102 transition into the screen lock mode and the determined keyboard idle times may be used to generate productivity statistics for the workers at the enterprise.

In one embodiment, the server 104 or another computing device may analyze the data received from the devices worn by the workers to determine, for example, when a worker (e.g., the first worker) is agitated or anxious (e.g., as indicated by voltage fluctuations resulting from ionic current flows within the neurons of the brain or an increased heart rate). The determination that the first worker, for example, is agitated or anxious may indicate to the server 104 and/or a worker at or outside the enterprise (e.g., the second worker) that the first worker is struggling with the work-related tasks. This information may be used by the server 104 and/or the worker at or outside the enterprise (e.g., the second worker), for example, to provide help for completing the work-related tasks to the first worker or to better allocate work to the workforce.

The plurality of computing devices 102 may send (e.g., periodically) status updates to the server 104 or another computing device. The status updates may include, for example, data representing what the workers are working on, the type of work the workers are working on, who does not have work, whether the workers are working on the correct work-related tasks, whether two or more of the workers switched work, and any other work-related information. A display associated with the server 104 or another computing device may display a symbol with a corresponding identifier representing each of the workers at the enterprise. The symbols and the corresponding identifiers may be linked to corresponding data stored at the server 104. For example, using an input device (e.g., a mouse and a keyboard) at the server 104, the second worker may select any of the symbols or identifiers on the display to view the corresponding status updates or the analysis of the data representing the monitored activities (e.g., the first worker is away from the first computing device 102a, the first worker has a large amount of idle time, the first worker is anxious). Based on the status updates, the server 104, for example, may calculate how long the workers are each taking to complete the work-related tasks and when the workers will each complete the work-related tasks (e.g., statistics). The calculated statistics, the status updates, and the analysis of the monitored activities may be used, for example, to monitor and re-allocate work to the workforce.

The server 104 determines when one of the monitored activities of the worker (e.g., data representing the one monitored activity) matches an identifier of one or more data records of the plurality of data records. The server 104 may compare at least some of the monitored activities (e.g., the subset of the monitored activities) of each of the workers at the plurality of computing devices 102 with the identifiers of the plurality of records. In one embodiment, the server 104 compares all of the monitored activities of each of the workers at the plurality of computing devices 102 with the identifiers of the plurality of records. The server 104 may compare the data representing the monitored activities to the identifiers of the plurality of data records (e.g., the textual data representing the plurality of user activities). For example, the server 104 may determine when the data representing the one monitored activity is the same as or similar to the textual data of the one or more data records.

Once the server 104 determines that the one monitored activity matches the identifier of the one or more data records, the server 104 may present the information corresponding to the one or more matched data records to the worker (e.g., the first worker). The server 104 may present part or all of the one or more matched data records to the worker. The server 104 may transmit, via the network 106, the one or more matched data records to the computing device 102 (e.g., the first computing device 102a) to be displayed. The server 104 may automatically transmit the one or more matched data records to the first computing device 102a when the server 104 determines that the one monitored activity matches the identifier of the one or more data records. Alternatively, the server 104 may generate identification data that identifies the one or more matched data records and provides an option for the first worker to receive the one or more matched data records. In such an embodiment, the server 104 may only transmit the one or more matched data records to the first computing device 102a when the first worker selects the option to receive the one or more matched data records (e.g., via a graphical user interface at the first computing device 102a).

In one embodiment, the server 104 may determine that the first worker, for example, is having difficulty completing a work-related task (e.g., as evidenced by pauses between actions). The server 104 may continuously determine (e.g., count) and store the number of times the first worker, for example, has completed the work-related task. The server 104 may also determine that the first worker is still learning and/or still in training for the work-related task based on the number of times the first worker has completed the work-related task and the one matched monitored activity (e.g., pauses between actions). In such a situation, the server 104 may respond by presenting the information corresponding to the one or more matched data records to the first worker and by redirecting a portion of the work-related task (e.g., a percentage of documents to be processed) to another worker (e.g., the second worker). This may provide the first worker with additional time to be trained under less time pressure.

The first computing device 102a, for example, may display or otherwise present (e.g., via audio and/or video) the one or more matched data records within a pop-up window within the graphical user interface of the first computing device 102a. The pop-up window within the graphical user interface may be rectangular, may cover a small area of a display of the first computing device 102a (e.g., less than ¼ of the display), and may be positioned near or at a corner of the display of the first computing device 102a. The pop-up window may be any number of other shapes and/or sizes, and may be disposed in any number of other positions on the display. In one embodiment, a chat function may be integrated with the pop-up window within the graphical user interface of the first computing device 102a, for example. Using the chat function, the first worker, for example, may be able to ask the worker that generated and/or last edited the one or more matched data records questions about the one or more matched data records. In other embodiments, the chat function may be separate from the pop-up window within the graphical user interface and may be used for other purposes (e.g., collaboration between workers when generating and/or editing the data records).

The one or more matched data records may be presented to the first worker in any number of other ways including, for example, within a text file within a word processing software program (e.g., MS Word) installed on the first computing device 102a. In one embodiment, the first worker may have the option to print the one or more matched data records using a printer in communication with the first computing device 102a (e.g., via the network 106 or directly connected to the first computing device 102a). In one embodiment, the first computing device 102a may automatically print the one or more matched data records when the first computing device 102a receives the one or more matched data records from the server 104. In one embodiment, the one or more matched data records may be presented to the first worker within a social network page corresponding to the first worker, such as the social network page generated by the social networking system disclosed in U.S. patent application Ser. No. 13/468,334 discussed above.

Different workers may simultaneously be presented different data records of the plurality of data records at different computing devices of the plurality of computing devices 102. Alternatively or additionally, one worker may, for example, be presented with information based on the activities of other workers. For example, if the system 100 determines that a large number of workers are having trouble completing a work-related task (e.g., a high QA failure rate), information relating to the work-related task may be provided to all users of the plurality of users (e.g., even those users of the plurality of user who have not yet performed the task or have note yet made a mistake). Activities may be linked in the database such that presentation of help based on a particular activity further triggers the display of related help, which may have also been triggered by another activity.

The server 104, which is in communication with the plurality of computing devices 102 and thus the one or more software programs operable to monitor activities of the workers running on the plurality of computing devices 102, may recognize and/or further analyze trends or patterns across multiple workers and tailor information presented to a worker (e.g., the first worker) accordingly. For example, if only the first worker is having difficulty with a work-related task (e.g., as indicated by pauses between actions), the information presented to the first worker may be different than if workers other than the first worker are having the same or similar difficulty with the work-related task (e.g., as indicated by pauses between actions).

The one or more matched data records may be presented to the worker based on comparisons between the matched monitored activity and previous matched monitored activities and amounts of time between the matched monitored activity and the previous matched monitored activities. Some or all of the matched monitored activities for each worker of the plurality of workers may be saved in the database 108 or another database. For example, for the first worker at the first computing device 102a, a first matched monitored activity, a second matched monitored activity, and a third matched monitored activity (e.g., three matched monitored activities), in temporal order from most recent to least recent, may be determined by the server 104 and saved to the database 108. The server 104 may determine more or fewer than three matched monitored activities. Other matched monitored activities may be determined between the first matched monitored activity and the second matched monitored activity, and between the second matched monitored activity and the third matched monitored activity. The first matched monitored activity may be the most recent matched monitored activity, or one or more other matched monitored activities may precede the first matched monitored activity.

The server 104 may determine an amount of time between the first matched monitored activity and the second matched monitored activity (e.g., a first amount of time), between the second matched monitored activity and the third matched monitored activity (e.g., a second amount of time), and thus between the first matched monitored activity and the third matched monitored activity (e.g., a third amount of time). The first amount of time, the second amount of time, and the third amount of time may be stored in the database 108 or another database. The server 104 may determine an amount of time between more or fewer of the matched monitored activities. The server 104 may determine amounts of time between matched monitored activities for some or all of the workers.

In one embodiment, the one or more data records (e.g., corresponding to the first matched monitored activity) are presented to the first worker when the first matched monitored activity is different than the second matched monitored activity. The second matched monitored activity is, for example, the matched monitored activity that is most recent before the first matched monitored activity (e.g., the matched monitored activity immediately preceding the first matched monitored activity). In such an embodiment, the system 100 presents information corresponding to the one or more data records only when the first worker switches to a different work-related task (e.g., as evidenced by the first matched monitored activity and the second matched monitored activity).

In another embodiment, the one or more data records (e.g., corresponding to the first matched monitored activity) are presented to the first worker when the first matched monitored activity is different than the second matched monitored activity, and an amount of time (e.g., the third amount of time) between the first matched monitored activity and the most recent matched monitored activity that is the same as or similar to (e.g., matched monitored activities that both relate to the same client) the first matched monitored activity (e.g., the third matched monitored activity) is greater than a first threshold amount of time. In such an embodiment, the system 100 presents information corresponding to the one or more data records when the first worker switches to a different work-related task (e.g., as evidenced by the first matched monitored activity and the second matched monitored activity), and a predetermined amount of time has passed since the first worker last worked on the different work related-task (e.g., as evidenced by the third amount of time between the first matched monitored activity and the third matched monitored activity). The first threshold amount of time may be set to any amount of time including, for example, one hour, one day, or one week. The first threshold amount of time may be set by any or only a subset of the workers at a computing device of the plurality of computing devices 102. Alternatively, the first threshold amount of time may be set by one of the users at one of the computing devices outside of the system 100. The first threshold amount of time may be saved to the database 108 or another database.

In yet another embodiment, the one or more data records (e.g., corresponding to the first matched monitored activity) are presented to the first worker when the first matched monitored activity is the same as or similar to the second matched monitored activity, and an amount of time (e.g., the first amount of time) between the first matched monitored activity and the second matched monitored activity is greater than a second threshold amount of time. The second matched monitored activity is, for example, the matched monitored activity that is most recent before the first matched monitored activity (e.g., the matched monitored activity immediately preceding the first matched monitored activity). In such an embodiment, the system 100 presents information corresponding to the one or more data records when the first worker continues working on the same work-related task (e.g., as evidenced by the first matched monitored activity and the second matched monitored activity), but a predetermined amount of time has passed since the first worker last worked on the same work related-task (e.g., as evidenced by the second amount of time between the first matched monitored activity and the second matched monitored activity). The second threshold amount of time may be set to any amount of time including, for example, one hour, one day, or one week. The second threshold amount of time may be set by any or a subset of the workers at a computing device of the plurality of computing devices 102. Alternatively, the second threshold amount of time may be set by one of the users at one of the computing devices outside of the system 100. The second threshold amount of time may be saved to the database 108 or another database. The second threshold amount of time may be different than the first threshold amount of time, as the workers may be more likely to forget the information corresponding to the one or more data records when the worker switches between work-related tasks. Any number of other amounts of time may be determined and used by the system 100 to determine when the one or more data records are to be presented, for example, to the first worker.

In one exemplary use of the system 100, the first user (e.g., the first worker) at the first computing device 102a may select a “Get Work” portion (e.g., a tab or a button) of a graphical user interface at the first computing device 102a. The “Get Work” portion of the graphical user interface may be part of an automated work distributor (AWD). The AWD may be integrated with a knowledge base storing the plurality of data records via the system 100. When the first worker selects the “Get Work” portion of the graphical user interface, the AWD may assign the first user work-related tasks via the first computing device 102a. The work-related tasks may be for a first client that the first worker has not or infrequently worked with in the past (e.g., as evidenced by the calculated amount of time since the first worker worked on/was assigned the work-related tasks). For example, the AWD may generate a window within the graphical user interface presenting the work-related tasks to be completed. Based on a mouse click or another user input accepting the assigned work-related tasks within the window, for example, the system 100 may determine, as described above, client-specific information related to the work-related tasks. The assigned work-related tasks may, for example, include identifying and separating documents of a group of documents that include a bank medallion signature. Different banks and/or different documents for a single bank may include bank medallions at different locations on the document. The client-specific information related to the work-related tasks may identify where on the documents (e.g., the different types of documents for the first client) the bank medallion signature may be found. By presenting the client-specific information to the first worker before the worker performs the work-related tasks, the worker does not have to learn as she goes (e.g., search for the bank medallion signature on each of the different documents and remember where the bank medallion signature is located on each of the different documents). Also, the first worker may not have to perform ad hoc searches of the knowledge base for the client-specific information. This may reduce the overall bandwidth required to identify and receive the client-specific information and may increase the speed, at which the client-specific information is presented to the first worker. The first worker may be more efficient in completing the work-related tasks, thus decreasing the cost involved with completing the work-related tasks.

The enterprise may gain operational efficiencies by using the system 100. For example, each of the workers may be assigned work-related tasks that the worker has not encountered or infrequently encounters. Using systems of the prior art, the workers may perform ad hoc searches of a database to find information that will aid in the completion of the infrequently encountered work-related tasks. Searches may take any amount of time (e.g., fifteen minutes), and in some instances, the worker may never find the correct information corresponding to the work-related tasks. In other words, the worker may perform the work-related tasks using the wrong information. For an enterprise employing several hundred workers performing document processing tasks, for example, the time and costs associated with the ad hoc searches and the incorrectly performed work-related tasks may be high. Using the system 100 of the present embodiments may reduce the number of ad hoc searches performed by the workers and may decrease errors caused by using the wrong information to complete the work-related tasks. Accordingly, the system 100 of the present embodiments may increase the efficiency of the workers, thus reducing costs associated with performing the work-related tasks.

FIG. 2 shows an illustrative embodiment of a general computer system 200. The computer system 200 may include a set of instructions that may be executed to cause the computer system 200 to perform any one or more of the methods or computer based functions disclosed herein. The computer system 200 may operate as a standalone device or may be connected (e.g., using a network) to other computer systems or peripheral devices. Any of the components discussed above may be a computer system 200 or a component in the computer system 200.

In a networked deployment, the computer system 200 may operate in the capacity of a server or as a client user computer in a client-server user network environment, or as a peer computer system in a peer-to-peer (or distributed) network environment. The computer system 200 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In one embodiment, the computer system 200 may be implemented using electronic devices that provide voice, video or data communication. Further, while a single computer system 200 is illustrated, the term “system” shall also be taken to include any collection of systems or sub-systems that individually or jointly execute a set, or multiple sets, of instructions to perform one or more computer functions.

As illustrated in FIG. 2, the computer system 200 may include a processor 202 such as, for example, a central processing unit (CPU), a graphics processing unit (GPU), or both. The processor 202 may be a component in a variety of systems. For example, the processor 202 may be part of a standard personal computer or a workstation. The processor 202 may be one or more general processors, digital signal processors, application specific integrated circuits, field programmable gate arrays, servers, networks, digital circuits, analog circuits, combinations thereof, or other now known or later developed devices for analyzing and processing data. The processor 202 may implement a software program, such as code generated manually (i.e., programmed).

The computer system 200 may include a memory 204 that may communicate via a bus 208. The memory 204 may be representative of the database 108. The memory 204 may be a main memory, a static memory, or a dynamic memory. The memory 204 may include but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 204 includes a cache or random access memory for the processor 202. In alternative embodiments, the memory 204 is separate from the processor 202, such as a cache memory of a processor, the system memory, or other memory. The memory 204 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 204 is operable to store instructions executable by the processor 202. The functions, acts or tasks illustrated in the figures or described herein may be performed by the programmed processor 202 executing the instructions stored in the memory 204. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 200 may further include a display unit 214, such as a liquid crystal display (LCD), an organic light emitting diode (OLED), a flat panel display, a solid state display, a cathode ray tube (CRT), a projector, a printer or other now known or later developed display device for outputting determined information. The display 214 may act as an interface for the user to see the functioning of the processor 202, or specifically as an interface with the software stored in the memory 204 or in a disk or optical drive unit 206 (e.g., a disk drive unit).

Additionally, the computer system 200 may include an input device 216 configured to allow a user to interact with any of the components of system 200. The input device 216 may be a number pad, a keyboard, or a cursor control device, such as a mouse, or a joystick, touch screen display, remote control or any other device operative to interact with the system 200.

In one embodiment, as depicted in FIG. 2, the computer system 200 may also include the disk or optical drive unit 206. The disk drive unit 206 may include a computer-readable medium 210, in which one or more sets of instructions 212 (e.g., software) may be embedded. Further, the instructions 212 may embody one or more of the methods or logic as described herein. In one embodiment, the instructions 212 may reside completely, or at least partially, within the memory 204 and/or within the processor 202 during execution by the computer system 200. The memory 204 and the processor 202 also may include computer-readable media as discussed above.

The present disclosure contemplates a computer-readable medium that includes instructions 212 or receives and executes instructions 212 responsive to a propagated signal, so that a device connected to a network 220 may communicate voice, video, audio, images or any other data over the network 220. Further, the instructions 212 may be transmitted or received over the network 220 via a communication port 218. The communication port 218 may be a part of the processor 202 or may be a separate component. The communication port 218 may be created in software or may be a physical connection in hardware. The communication port 218 is configured to connect with the network 220 or another network, external media, the display 214, any other components in system 200, or combinations thereof. The connection with the network 220 may be a physical connection, such as a wired Ethernet connection or may be established wirelessly as discussed below. Likewise, the additional connections with other components of the system 200 may be physical connections or may be established wirelessly.

The network 220 may include wired networks, wireless networks, or combinations thereof, and may be representative of the network 106. The wireless network may be a cellular telephone network, an 802.11, 802.16, 802.20, or WiMax network. Further, the network 220 may be a public network, such as the Internet, a private network, such as an intranet, or combinations thereof, and may utilize a variety of networking protocols now available or later developed including, but not limited to TCP/IP based networking protocols.

While the computer-readable medium is shown to be a single medium, the term “computer-readable medium” includes a single medium or multiple media (e.g., a centralized or distributed database and/or associated caches and servers that store one or more sets of instructions). The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium may include a solid-state memory such as a memory card or other package that houses one or more non-volatile read-only memories. Further, the computer-readable medium may be a random access memory or other volatile re-writable memory. Additionally, the computer-readable medium may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In one embodiment, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limiting embodiment, implementations may include distributed processing, component/object distributed processing, and parallel processing. Alternatively, virtual computer system processing may be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

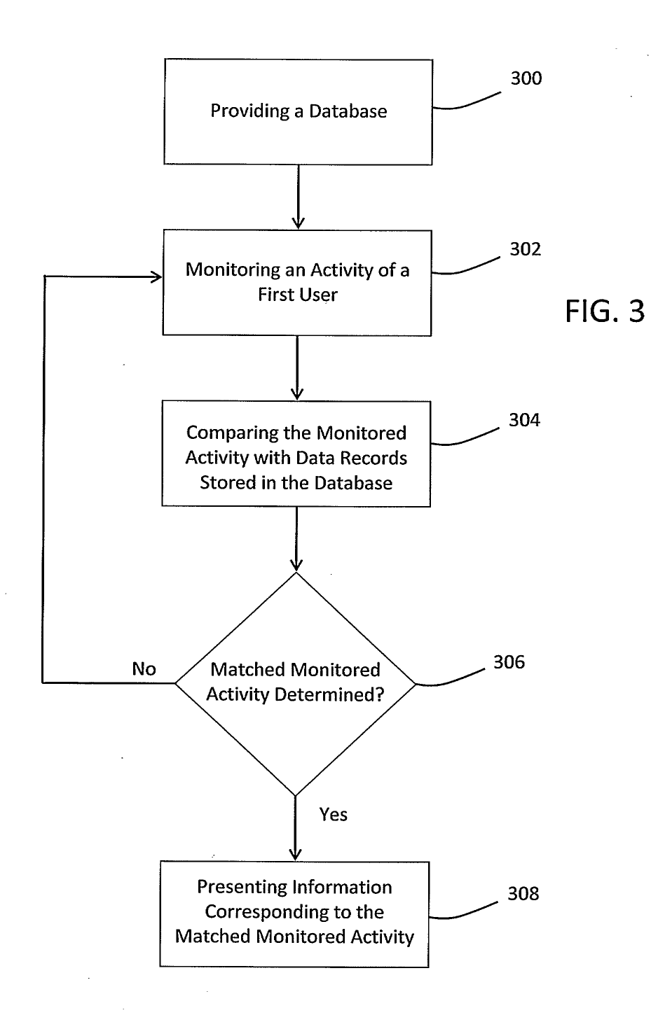

FIG. 3 shows a flowchart of one embodiment of a method for presenting information, relevant to user activity, to a first user at a first computing device. The method may be performed using the system 100 shown in FIG. 1 or another system. The method is implemented in the order shown, but other orders may be used. Additional, different, or fewer acts may be provided. Similar methods may be used for presenting information relevant to user activity.

The method includes providing a database including a plurality of data records (act 300). Each data record of the plurality of data records includes information relevant to at least one user activity of a plurality of user activities and at least one identifier identifying the at least one corresponding user activity. Each data record may include data for helping the first user complete a work-related task. For example, the data may be for client-specific exceptions and/or instructions for completing the work-related task. The instructions may be step-by-step procedural job aids that correspond to the work-related task. In one embodiment, the work related task involves processing documents. The step-by-step procedural job aids may be for one or more documents and/or one or more tasks related to a specific client.

The database may be part of or separate from a server. The server may be in communication with a plurality of computing devices via a network. The first user may interact with a first computing device of the plurality of computing devices (e.g., provide inputs at the first computing device). The first user and/or other users may generate at least parts of some or all of the data records of the plurality of data records via the computing device and/or other computing devices of the plurality of computing devices. The generated data records may be transmitted to the server, for example, and stored in the database. The first user and/or the other users may update the generated data records. The updates may replace the generated data records, supplement the generated data records, or a combination thereof.

An activity of the first user at the first computing device, for example, is monitored (act 302). For example, data traffic to and/or from each computing device (e.g. the first computing device) of the plurality of computing devices via the network may be monitored. One or more software programs that intercept packets to and/or from each computing device of the plurality of computing devices 102 and examine contents of the intercepted packets, may be installed and run on the server and/or some or all computing devices of the plurality of computing devices. At least some computing devices of the plurality of computing devices may also run one or more software programs operable to monitor activities of the user (e.g., the first user) using the computing device (e.g., the first computing device) and/or examine data stored at the computing device. The monitored activity of the user may include any number of activities including, for example, opening a file, selecting a portion of a graphical user interface (e.g., a window) displayed at the computing device, receiving data, and/or transmitting data.

The monitored activity of the first user is compared to at least some data records of the plurality of data records of the database (act 304). Data representing the monitored activity may be compared to the identifiers of the plurality of data records. The server may determine if the monitored activity matches one or more data records of the plurality of data records (act 306). For example, the data representing the monitored activity may be compared to the identifiers of the plurality of data records. If the server determines that the monitored activity does not match one or more data records of the plurality of data records, the method may return to act 302, where activity of the first user is again monitored at the first computing device, for example. If the server determines that the monitored activity does match one or more data records of the plurality of data records, information corresponding to the one or more matched data records is presented to the first user at the first computing device, for example (act 308). In one embodiment, the information corresponding to the one or more matched data records may be automatically presented to the first user at the first computing device when the server determines that the monitored activity matches the one or more data records. The information corresponding to the one or more matched data records may be presented to the first user via a graphical user interface at the first computing device. For example, the information corresponding to the one or more matched data records may be presented to the first user in a pop-window within the graphical user interface at the first computing device. The server and/or the first computing device, for example, may continuously monitor activities of the first user at the first computing device and present information corresponding to matched data records, whenever the matched data records are determined (e.g., when monitored activities match data records). In one embodiment the server and/or the first computing device, for example, may monitor activities of the first user during specific time periods such as, for example, hours, during which the first user works, and/or when the first user is logged onto the first computing device.

A plurality of matched monitored activities may be determined for some or all of the users. For example, for the first user, the plurality of matched monitored activities may include the matched monitored activity determined in act 306 (e.g., a current matched monitored activity or a first matched monitored activity), a second matched monitored activity, and a third matched monitored activity. The second matched monitored activity and the third matched monitored activity may temporally precede the first matched monitored activity.

In one embodiment, the second matched monitored activity may be the most recent matched monitored activity before the first matched monitored activity. In act 308, the information corresponding to the one or more matched data records may be presented to the first user at the first computing device when the first matched monitored activity is different than the second matched monitored activity.

In one embodiment, the server may calculate or determine an amount of time between each or some of the matched monitored activities. For example, a first amount of time may be calculated or determined between the first matched monitored activity and the second matched monitored activity, a second amount of time may be calculated or determined between the second matched monitored activity and the third matched monitored activity, and a third amount of time may be calculated or determined between the first matched monitored activity and the third matched monitored activity. The second matched monitored activity may be the most recent matched monitored activity that is the same as the first matched monitored activity. In act 308, the information corresponding to the one or more matched data records may be presented to the first user at the first computing device, for example, when the first matched monitored activity is the same as the second matched monitored activity, and the first amount of time is greater than a first predetermined threshold amount of time.

In another embodiment, the first matched monitored activity and the second matched monitored activity may be different, and the first matched monitored activity and the third matched monitored activity may be the same. The third matched monitored activity may be the most recent matched monitored activity before the first matched monitored activity that is the same as the first matched monitored activity. In act 308, the information corresponding to the one or more matched data records may be presented to the first user at the first computing device, for example, when the first matched monitored activity is the same as the third matched monitored activity, and the third amount of time is greater than a second predetermined threshold amount of time.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is therefore intended that the foregoing detailed description be regarded as illustrative rather than limiting, and that it be understood that it is the following claims, including all equivalents, that are intended to define the spirit and scope of this invention.

We claim:

1. A method for presenting information, relevant to user activity, to a first user at a first computing device, the method comprising:
providing a database including a plurality of data records, each data record of the plurality of data records comprising information relevant to at least one user activity of a plurality of user activities and at least one identifier identifying the at least one corresponding user activity;
monitoring activities of the first user and comparing each of the monitored activities with the plurality of data records stored in the database;
determining when a monitored activity matches an identifier of one data record of the plurality of data records; and
presenting the information corresponding to the one matched data record to the first user.

2. The method of claim 1, further comprising:
receiving a data record of the plurality of data records from a second user at a second computing device; and
storing the received data records in the database.

3. The method of claim 2, further comprising receiving an update for the data record from the second user or from a third user at a third computing device, the update for the data record replacing, supplementing, or replacing and supplementing the data record.

4. The method of claim 1, wherein the matched monitored activity is a first matched monitored activity, and
wherein a plurality of matched monitored activities is determined, the plurality of matched monitored activities comprising the first matched monitored activity and a second matched monitored activity, the second matched monitored activity temporally preceding the first matched monitored activity.

5. The method of claim 4, wherein the second matched monitored activity is the matched monitored activity that immediately precedes first matched monitored activity, and
wherein presenting comprises presenting the information corresponding to the one matched data record when the first matched monitored activity is different than second matched monitored activity.

6. The method of claim 4, wherein the method further comprises calculating an amount of time between the first matched monitored activity and the second matched monitored activity.

7. The method of claim 6, wherein the presenting comprises presenting the information corresponding to the one matched data record when the first matched monitored activity is the same as the second matched monitored activity and the calculated amount of time is greater than a predetermined threshold amount of time.

8. The method of claim 7, wherein the plurality of matched monitored activities comprises a third matched monitored activity, the third matched monitored activity temporally preceding the first matched monitored activity and temporally following the second matched monitored activity, and
wherein the first matched monitored activity and the third matched monitored activity are different.

9. The method of claim 1, wherein the plurality of user activities comprises opening a file at the first computing device, selecting a portion of a graphical user interface displayed at the first computing device, sending data from the first computing device, or receiving data at the first computing device.

10. The method of claim 1, wherein the information corresponding to the one matched data record is automatically presented to the first user when the match is determined.

11. The method of claim 1, wherein the plurality of data records comprise different enterprise-specific processing information for document processing.

12. The method of claim 11, wherein the data for different enterprise-specific processing information for document processing comprises data for step-by-step procedural job aids and data for client-specific exceptions for the document processing.

13. In a computer readable storage medium having stored therein data representing instructions executable by a programmed processor for facilitating a transition between frequently encountered work and infrequently encountered work for a first user at a first computing device, the instructions comprising:
storing, in a database, a plurality of data records, each data record of the plurality of data records comprising information relevant to at least one user activity of a plurality of user activities and at least one identifier identifying the at least one corresponding user activity
monitoring activities of the first user and comparing each of the monitored activities with the plurality of data records stored in the database;
determining when the monitored activity matches an identifier of one data record of the plurality of data records; and
presenting the information corresponding to the one matched data record to the first user.

14. The computer readable storage medium of claim 13, wherein the matched monitored activity is a first matched monitored activity, and
wherein a plurality of matched monitored activities is determined, the plurality of matched monitored activities comprising the first matched monitored activity and a second matched monitored activity, the second matched monitored activity temporally preceding the first matched monitored activity.

15. The computer readable storage medium of claim 14, wherein the second matched monitored activity is the matched monitored activity that immediately precedes the first matched monitored activity, and
wherein presenting comprises presenting the information corresponding to the one matched data record when the first matched monitored activity is different than second matched monitored activity.

16. The computer readable storage medium of claim 14, wherein the instructions further comprise calculating an amount of time between the first matched monitored activity and the second matched monitored activity.

17. The computer readable storage medium of claim 16, wherein presenting the information corresponding to the one matched data record comprises presenting the information corresponding to the one matched data record when the first matched monitored activity is the same as the second matched monitored activity and the calculated amount of time is greater than a predetermined threshold amount of time.

18. A system for presenting information, relevant to user activity, to a first user at a first computing device, the system comprising:
a database including a plurality of data records, each data record of the plurality of data records comprising information relevant to at least one user activity of a plurality of user activities and at least one identifier identifying the at least one corresponding user activity;
a processor configured to:
monitor activities of the first user and compare each of the monitored activities with the plurality of data records stored in the database;
determine when a monitored activity matches an identifier of one data record of the plurality of data records; and
present the information corresponding to the one matched data record to the first user.

19. The system of claim 18, wherein the matched monitored activity is a first matched monitored activity, and
wherein the processor is configured to determine a plurality of matched monitored activities, the plurality of matched monitored activities comprising the first matched monitored activity and a second matched monitored activity, the second matched monitored activity temporally preceding the first matched monitored activity.

20. The system of claim 19, wherein the second matched monitored activity immediately precedes the first matched monitored activity, and
wherein the processor is configured to present the information corresponding to the one matched data record when the first matched monitored activity is different than second matched monitored activity.

21. The system of claim 19, wherein the processor is further configured to calculate an amount of time between the first matched monitored activity and the second matched monitored activity.

22. The system of claim 21, wherein the processing is configured to present the information corresponding to the one matched data record when the first matched monitored activity is the same as the second matched monitored activity and the calculated amount of time is greater than a predetermined threshold amount of time stored in the database or another memory.
